(19) United States
(12) Patent Application Publication
(10) Pub. No.: US 2026/0115680 A1
(43) Pub. Date: Apr. 30, 2026

(54) METHOD AND SYSTEM FOR PRODUCING SILICON

(71) Applicant: GREEN 14 AB, Stockholm (SE)

(72) Inventor: Adam PODGORSKI, Stockholm (SE)

(21) Appl. No.: 19/479,529

(22) PCT Filed: May 2, 2024
(86) PCT No.: PCT/SE2024/050421

§ 371 Date: Oct. 28, 2025

(30) Foreign Application Priority Data
May 2, 2023 (SE) 2350527-4

(51) Int. Cl. B01J 19/08; B01J 19/12

(52) U.S. Cl. CPC B01J 19/088; B01J 19/126; B01J 19/129; B01J 2219/0807; B01J 2219/0894; B01J 2219/1221

(57) ABSTRACT

Device (100,200) for processing a substance, its oxide and/or its sulphide, the substance being a metal or metalloid, the device (100,200) comprising a reaction chamber (110,210) and an expansion chamber (120,220); a plasma generator device (160,260), arranged to emit a plasma stream (163,263) into the reaction chamber (110,210), the plasma stream (163,263) comprising said material; a gas provision means (170), arranged to provide an inert (171) and/or reducing (172) gas to the reaction chamber (110,210); a DeLaval nozzle (180,280), arranged to convey gases from the reaction chamber (110,210) to the expansion chamber (120,220) and arranged to lower the temperature of the gases passing through the DeLaval nozzle (180,280) to below the condensation temperature of the substance, causing the gas compound to condense into a liquid or solid phase; and a vessel (190,290), into which the condensed substance is directed by the DeLaval nozzle (180,280). The invention also relates to a method.

The present invention relates to a method and a system for producing high-purity silicon or other metal or metalloids.

Production of high-purity silicon, for instance for use in solar panels, currently gives rise to unwanted carbon dioxide emissions. There is therefore a need to move towards non-carbonaceous reductants for reducing SiO₂ into Si that also produces Si of a sufficient purity to avoid the use of additional purification steps.

One possible such reductant is hydrogen. Unfortunately, the hydrogen-silica gas system requires elevated temperatures as high as 3000° C. to operate effectively.

The use of plasma is one possible way of getting around these unfavourable thermodynamics, using instead kinetics in turn reducing the reactor temperatures to below 2000° C. where refractory materials can still function properly. Hence, plasma can be a mechanism of providing activated species for reduction, to reduce the required temperature of reaction. Local very high enthalpy changes where plasma itself rapidly cools allows for a lower average temperature, with control over where and how high enthalpy changes are applied to oxides. However, plasma itself operates at very high temperatures but with low heat capacity of the molecules involved, which then contributes to elevated temperatures that result in side reactions and re-oxidation of silicon.

There are several different methods of forming the plasma state and applying it as a discharge to reduce a material. Where a plasma is simply a gas wherein a large portion of constituent atoms are ionised, plasma can be formed by applying power to ionise the gas via direct- or alternating-current. DC plasmas include transferred arc (TAP) and non-transferred arc plasmas (NTAP). AC or radiofrequency (Rf) plasmas include inductively coupled plasma (ICP), capacitively coupled plasma CCP and microwave plasma. The gas is supplied between the electrodes for DC configurations and within the electric field for Rf and microwave plasmas. As energy flows into the ionised gas via the arc current within a confined space, the flow then accelerates. For NTAPs, the flow can approach the speed of sound. The specific energy of the plasma is defined as the ratio between the power supplied and the plasma gas flow rate: P=W/Q.

DC discharges can be differentiated into TAP and NTAP by the set-up of the anode. The cathode is usually arranged upstream in the gas inflow with respect to the anode. If the anode is arranged in an electric circuit configuration such that it is distinct from the target melt or workpiece, then it is an NTAP set-up, and the anode can be the nozzle of the plasma torch device. If the anode is the workpiece or target melt or slag itself, then it is known as TAP—the arc is then transferred to the workpiece. Temperatures for DC discharge plasmas (hot plasmas) can reach up to 28 000 K but in the present solutions the maximum temperature may only be as high as 15 000 K; the pressure (from a few millitorr up to a few millibar) and flow rate of the gas on the order of 10⁰-10² litres per minute is usually lower than AC plasmas with a higher electric current on the order of 10¹-10² amperes.

AC plasmas can be generated by supplying the required electric current to the input gas flow via electromagnetic induction; the gas itself can conduct electrons through a small population of atoms that are ionised in thermal collisions or gamma rays. The gas is subjected to a changing magnetic field through provided AC power at a typical 13.56 MHz for ICP Rf plasmas (see U.S. Pat. No. 4,626,767 A) and through magnetrons operating at 2.45 GHz or 915 MHz for microwave CCPs; other frequencies are also possible depending on the required wavelength of the generated radiation. In ICPs, this changing magnetic field can be supplied via an AC current through planar, cylindrical, or toroidal coils; in CCPs the magnetic field is generated through applying AC to a capacitor in an electric circuit with gas in between the capacitor plates or a cylindrical cathode in a coaxial anode. The resulting electromotive force in the gas is proportional to the rate of change of the magnetic field with respect to time, giving rise to an electric field and providing motion and incident ionisation to electrons. Given the lower heat capacity of electrons, AC plasmas operate at lower temperatures than DC plasmas, for instance at 5500° C.-6000° C. The pressure on the order of 10¹-10³ millitorr and flow rate of the gas on the order of 10¹-10³ litres per minute is usually higher than DC plasmas with a lower electric current on the order of 10⁰-10¹ amperes.

Glow discharge plasmas, a type of CCP, have been generally known to produce coatings via hydrogen reduction via plasma enhanced chemical vapour deposition (PECVD) since the 1960s (see FR 1442502 A, GB 1104935 A) to deposit amorphous silicon, silicon nitride and silicon dioxide. Such Rf plasmas often use 13.56 MHz frequency for industrial use (again, see U.S. Pat. No. 4,626,767 A). Hydrogen reducing ICP has also been used to reduce SF₆ at ratios of flows of H₂/SF₆ equal to 6 with maximum yields of 70% (see Mochalov et al., ‘Investigation of the Process of Hydrogen Reduction of 32S from 32SF6 via RF Capacitive Plasma Discharge’). It has also been used to deposit carbon-tungsten layers (see Katayama et al., ‘Hydrogen Retention in Carbon-Tungsten Co-Deposition Layer Formed by Hydrogen RF Plasma’). Hydrogen plasma is therefore also a candidate for silica reduction and silicon deposition but can be limited by its lower yield.

One possibility would be to modify existing electric arc furnaces used for carbothermic reduction in a DC transferred arc (TAP) mode to achieve the following overall reaction:

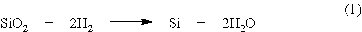

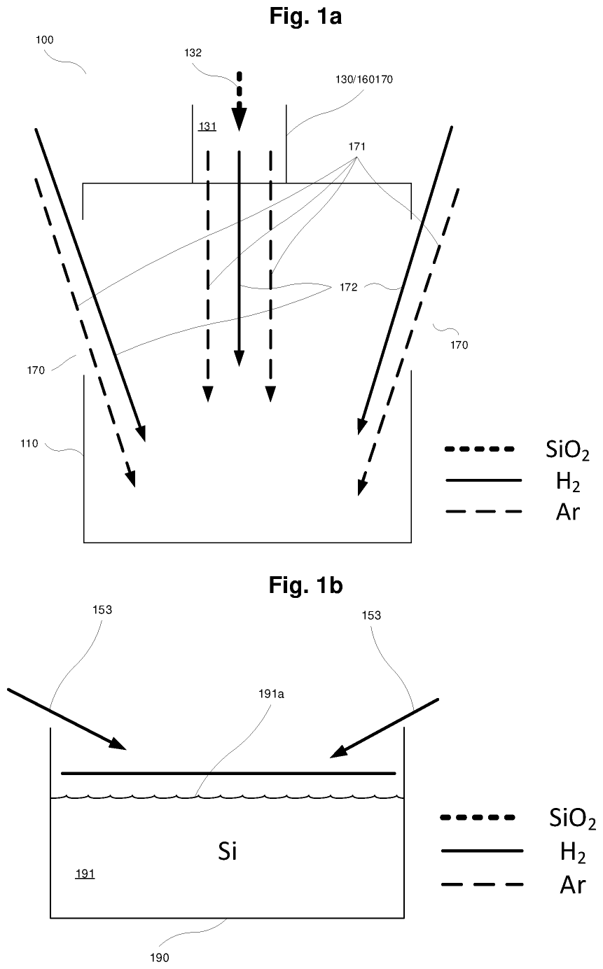

This could, for example, entail using a vacuum electric arc furnace (VEAF) utilising transferred arc technology similar to that described in US 2018/0237306 A1. The transferred arc set-up (see FIG. 1 of US 2018/0237306 A1) would then use a small distance to arc (denoted 6 in said FIG. 1 of this document) between the melt (7) and the graphite cathode (4). Conventional EAFs (Electric Arc Furnaces) in silicon production typically use electrodes that are submerged in the charge or melt and do not use vacuum.

This VEAF set-up, however, has shown to pose several issues in switching over to hydrogen gas or plasma as a reducing agent instead of the carbonaceous reductant media, making the switch difficult.

As will be described in fuller detail below, the present inventors have devised a number of experiments to modify the existing technology in order to be able to produce high-purity silicon but while avoiding one or several of the drawbacks described above. Corresponding techniques have turned out to be useful also for remelting of solid-state Si.

Prior art solutions also include WO 2007/102745 A1 and US 2012/020461 A1.

One or several of the above-described challenges exist also for production of other metals or metalloids at high purity, such as beryllium, gallium, germanium, lithium, niobium, tantalum, titanium, tungsten, vanadium, aluminium, copper, indium, lead, tellurium, zinc, nickel or cobalt.

Hence, the invention relates to a device for processing a compound, its oxide and/or its sulphide, the compound being a metal or metalloid, the device comprising
a reaction chamber and an expansion chamber;
a plasma generator device, arranged to emit a plasma stream into the reaction chamber, the plasma stream comprising the compound, its oxide and/or its sulphide;
a first material provision means, arranged to provide material comprising the compound, its oxide and/or its sulphide to the plasma generator device;
a gas provision means, arranged to provide an inert and/or reducing gas to the reaction chamber;
a DeLaval nozzle, arranged to convey gases from the reaction chamber to the expansion chamber, the DeLaval nozzle being arranged to lower the temperature of the gases passing through the DeLaval nozzle to below the condensation temperature of the compound, its oxide and/or its sulphide, so that the compound, oxide and/or sulphide entering the DeLaval nozzle (180,280) in gaseous form as a result from passing through the DeLaval nozzle condenses into a liquid or solid phase; and
a vessel, into which the condensed compound is directed by the DeLaval nozzle.

The invention also relates to a device for processing a compound, its oxide and/or its sulphide, the device comprising
a chamber, comprising a peripherally arranged off-gas exit;
a plasma generator device, arranged to emit a plasma stream into the chamber, the plasma stream comprising the compound, its oxide and/or its sulphide;
a first material provision means, arranged to provide material comprising the compound, its oxide and/or its sulphide to the plasma generator device;
a gas provision means, arranged to provide an inert and/or reducing gas to the chamber; and
a vessel, into which the plasma stream is directed so that the compound is deposited directly into a melt of the compound arranged in the vessel without first solidifying.

In some embodiments, the plasma generator device is arranged to provide the plasma stream to the vessel at a velocity which is sufficient to cause H₂O in the plasma stream to migrate radially outwards along the movement direction of the plasma stream, due to the Saffman lift force at effective Stokes numbers above a certain threshold, such as 2.8, towards a region where the H₂O is caused to migrate radially outwards towards the off-gas exit, due to turbophoresis at effective Stokes numbers below said threshold.

In some embodiments, the plasma generator device is a non-transferred arc device operated using DC voltage, an AC voltage using device such as a radio frequency RF or inductively coupled plasma ICP, a microwave plasma device or a capacitively coupled plasma CCP device.

In some embodiments, the gas provision means is arranged to provide hydrogen so as to achieve above-stoichiometric amounts of hydrogen for full reduction of an oxide of the compound present in the reaction chamber.

In some embodiments, the first material provision means is arranged to provide the material circumferentially around an anode of the plasma generator device or through the anode.

In some embodiments, the first material provision means is arranged to provide the compound, its oxide and/or its sulphide as solid-state compound, oxide and/or sulphide having a mean particle size of between 20 and 200 μm, such as between 50 and 100 μm, preferably with more than 99% of the particles of a size within such a range.

In some embodiments, the compound, its oxide and/or its sulphide provided to the plasma generator device is heated in the plasma stream so that the compound atoms in the plasma stream have a temperature which is above the evaporation temperature of B, Ti, Al, Fe, Ca, Na, Ni, P and/or W at the relevant operating pressure at the gas-liquid interface.

In some embodiments, the first material provision means is arranged to provide at least one of hydrogen and a chemically non-reactive species, such as an inert gas, to the plasma generator device, in addition to the compound, its oxide and/or its sulphide, the chemically non-reactive species possibly being Ar, He, or N₂.

In some embodiments, the chamber comprises a reaction chamber arranged upstream of an expansion chamber, the reaction chamber being axially separated from the expansion chamber by a constriction.

In some embodiments, the device further comprises a second material provision means, arranged to supply at least one of hydrogen and a chemically non-reactive species, such as an inert gas, into the reaction chamber peripherally to the plasma stream, the chemically non-reactive species possibly being Ar, He, or N₂.

In some embodiments, the second material provision means is arranged to provide said hydrogen and/or said chemically non-reactive species so as to cause a laminar flow in a radially outer sheath of a plasma reaction zone in the reaction chamber.

In some embodiments, the second material provision means is arranged to provide said hydrogen and/or said chemically non-reactive species so as to cause a shroud of the supplied hydrogen and/or the chemically non-reactive species upon entry into the constriction, the shroud being provided at the entry around material arriving to the constriction from the plasma stream.

In some embodiments, the second material provision means is arranged to provide said hydrogen and/or said chemically non-reactive species at a temperature of maximally 1500° C.

In some embodiments, the device is arranged to provide a surplus of H₂ in relation to stoichiometric conditions inside the reaction chamber entirely via said second material provision means.

In some embodiments, the device is arranged to provide H₂ at a surplus, in relation to stoichiometric conditions inside the reaction chamber, of at least 50%, such as at least 100%.

In some embodiments, the reaction chamber is a vacuum chamber having a pressure of at the most 800 mbar, such as at the most 100 mbar, such as between 1 and 50 mbar, such as between 5 and 20 mbar.

In some embodiments, the constriction is arranged so that the condensed compound exiting the constriction is directed towards, and deposited directly into, a melt of the compound provided in the vessel below the constriction.

In some embodiments, an axial length of the expansion chamber length is at least 10 times, such as between 20 and 40 times, as compared to an axial length of the reaction chamber.

In some embodiments, the first material provision means is arranged so that the plasma stream contains between 30-70% carrier gas in the form of a chemically non-reactive species and between 30-70% H₂.

In some embodiments, the carrier gas in the plasma stream has a temperature of 5-15 kk resulting from energy applied to the gas via DC or AC circuit.

In some embodiments, the plasma generator device is arranged to heat the H₂ in the plasma stream to at least 2 kK.

In some embodiments, the plasma generator device is arranged so that the plasma stream, directly after an exit of the plasma generator device, has a temperature of 5-15 kK.

In some embodiments, the reaction chamber has a cross-sectional radius of between 120% and 300% of an exit diameter of the plasma generator device.

In some embodiments, an upstream convergent section of the DeLaval nozzle has a radius of curvature which is within 50% of a cross-sectional radius of the reaction chamber.

In some embodiments, the DeLaval nozzle is arranged so as to result in a turbulent gas flow in the expansion chamber.

In some embodiments, the DeLaval nozzle is designed to provide an exit velocity of gasses passing through the DeLaval nozzle that is below the melting temperature of an oxide of the compound.

In some embodiments, the DeLaval nozzle is designed to provide an exit velocity of gasses passing through the DeLaval nozzle that is between the melting temperature of the compound and that of its oxide.

In some embodiments, the DeLaval nozzle is arranged so that condensed compound exiting the DeLaval nozzle is directed towards, and deposited directly into, a melt of the compound provided in the vessel below the DeLaval nozzle exit.

In some embodiments, the device further comprises a third material provision means, arranged to provide at least one of hydrogen and a chemically non-reactive species, such as an inert gas, to the chamber, such as to the expansion chamber, the chemically non-reactive species possibly being Ar, He, or N₂.

In some embodiments, the third material provision means comprises a non-transferred plasma torch providing said hydrogen and/or said chemically non-reactive species, a plasma stream thereof being arranged to impinge directly onto a surface of a melt of the compound in said vessel.

In some embodiments, the third material provision means comprises a non-transferred plasma torch providing said hydrogen and/or said chemically non-reactive species, a plasma stream thereof being arranged below a surface of a melt of the compound in said vessel.

In some embodiments, the third material provision means is arranged to operate the non-transferred plasma torch in question intermittently, such as using a duty cycle of at the most 50%.

In some embodiments, the third material provision means is arranged to provide said hydrogen and/or said chemically non-reactive species by applying an electrical plasma torch power of 0-20% as compared to an electrical plasma torch power applied to produce the plasma stream of the plasma generator device.

In some embodiments, the vessel comprises an upper part, arranged to accommodate an upper surface of liquid compound deposited from the plasma stream, and a lower part, arranged below the upper part and to accommodate the compound arriving from said upper part.

In some embodiments, the lower part comprises heating elements arranged to control a solid-liquid interface of the compound in the compound melt.

In some embodiments, the chamber comprises an inner wall, the inner wall being coaxially arranged along a main axis of the chamber and comprising one or several perforations through the inner wall so as to allow gas to exit from a radially central zone in the chamber, located inside of the inner wall, to a radially peripheral zone in the chamber, located peripherally outside of the inner wall.

In some embodiments, the peripheral zone is connected to a peripheral off-gas exit arranged in the chamber.

In some embodiments, the peripheral zone is open at an upper end of the inner wall so as to allow gas to flow from the peripheral zone to the central zone.

In some embodiments, the device further comprises a fourth material provision means, arranged to provide hydrogen gas to the central zone.

In some embodiments, the vessel comprises a tap-off line for liquid impurities, arranged below a liquid surface of liquid compound deposited from the plasma stream and present in the vessel.

The invention also relates to a method for operating a device of said type for processing the compound, its oxide and/or its sulphide, the compound being a metal or metalloid, the method comprising
causing the plasma generator device of the device to emit a plasma stream into the chamber of the device, the plasma stream comprising the compound, its oxide and/or its sulphide;
causing the first material provision means of the device to provide material comprising the the compound, its oxide and/or its sulphide to the plasma generator device;
causing the gas provision means of the device to provide an inert and/or reducing gas to the chamber;
causing H₂O to exit the chamber via the peripherally arranged off-gas exit of the device; and directing the condensed compound into, and collecting the condensed compound in, the vessel of the device without first solidifying.

The invention also relates to a method for operating a device of said type for processing a compound, its oxide and/or its sulphide, the compound being a metal or metalloid, the method comprising
causing the plasma generator device of the device to emit a plasma stream into the reaction chamber of the device, the plasma stream comprising the compound, its oxide and/or its sulphide;
causing the first material provision means of the device to provide material comprising the the compound, its oxide and/or its sulphide to the plasma generator device;
causing the gas provision means of the device to provide an inert and/or reducing gas to the reaction chamber;
causing the DeLaval nozzle of the device to convey gases from the reaction chamber to the expansion chamber, thereby lowering the temperature of the gases passing through the DeLaval nozzle to below the condensation temperature of the compound, its oxide and/or its sulphide, so that the compound, oxide and/or sulphide entering the DeLaval nozzle (180,280) in gaseous form as a result from passing through the DeLaval nozzle condenses into a liquid or solid phase; and
directing the condensed compound into, and collecting the condensed compund in, the vessel of the device without first solidifying.

In the following, the invention will be described in detail, with reference to exemplifying embodiments of the invention and to the enclosed drawings, wherein:

FIG. 1a is a schematic diagram of a hydrogen shrouding and an inert gas jacket in relation to a plasma stream;

FIG. 1b is a schematic diagram of a hydrogen provision close to the surface of a silicon melt;

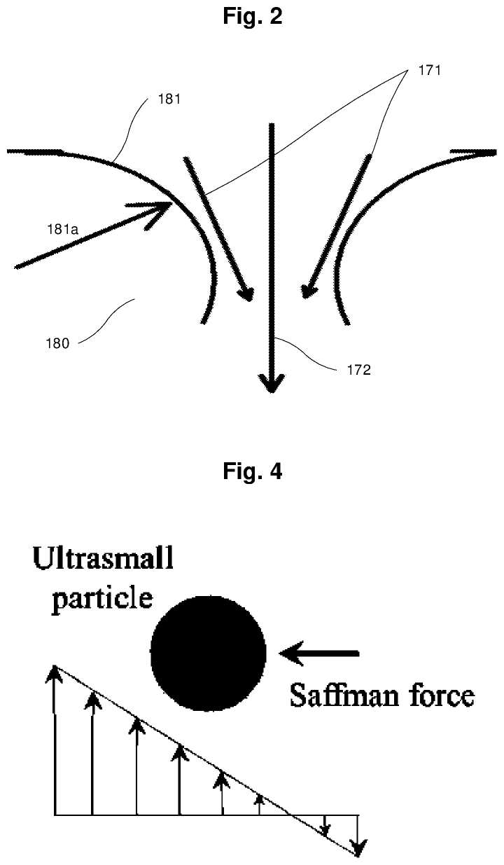

FIG. 2 illustrates a DeLaval nozzle;

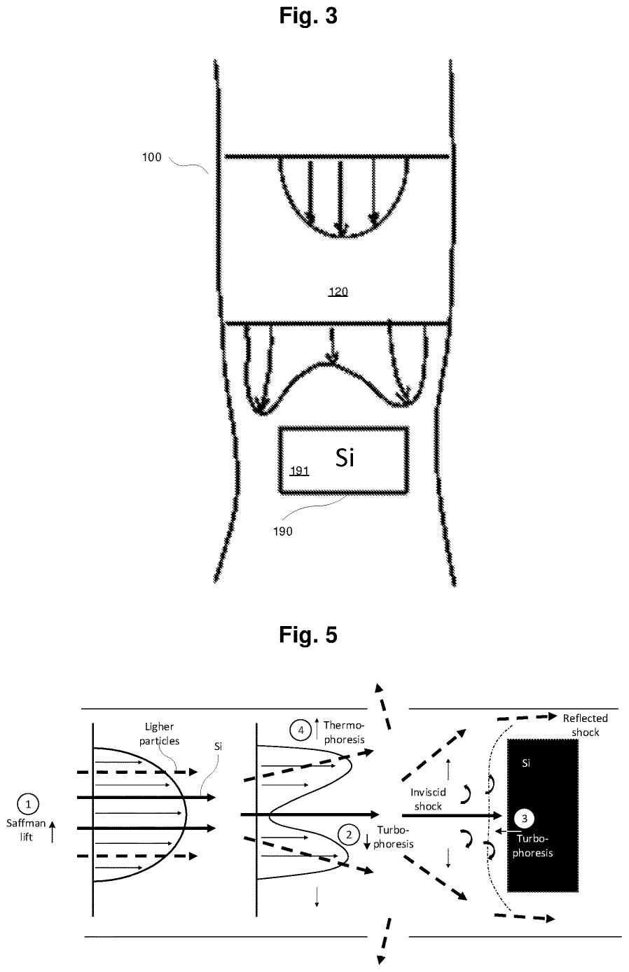

FIG. 3 is a turbophoresis axial flow velocity diagram;

FIG. 4 illustrates the Saffman lift force onto a small particle;

FIG. 5 is an overview flow diagram illustrating various physical effects impacting the flow inside a reactor;

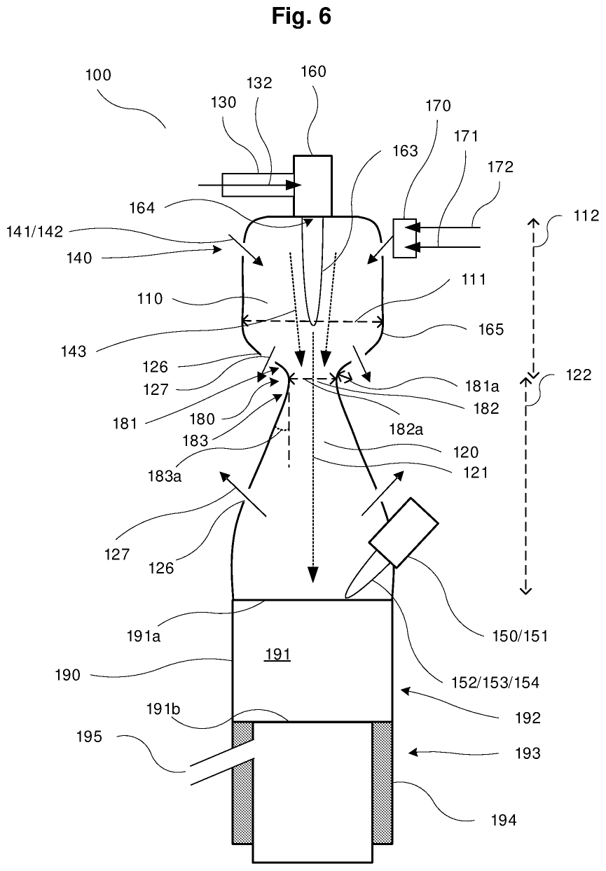

FIG. 6 is a simplified overview diagram of a first exemplary embodiment;

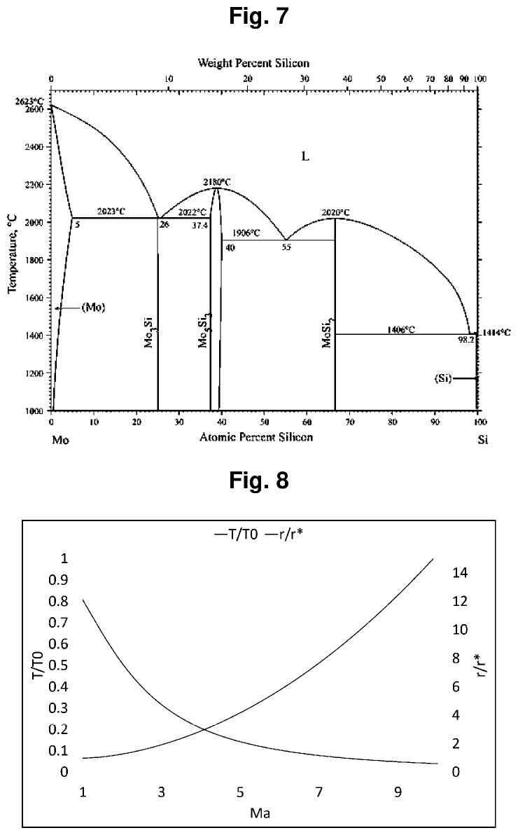

FIG. 7 shows a phase diagram for a molybdenum-silicon system;

FIG. 8 shows a temperature drop across a convergent-divergent nozzle with respect to Mach number of the gas thus expanding;

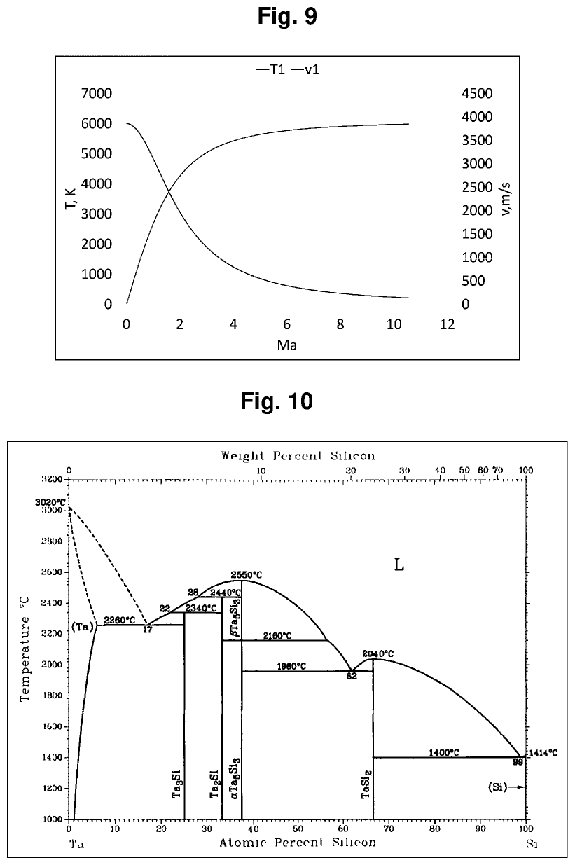

FIG. 9 is a chart illustrating gas velocity as a function of temperature in a supersonic flow through a DeLaval nozzle;

FIG. 10 is a Phase diagram for a Ta—Si system;

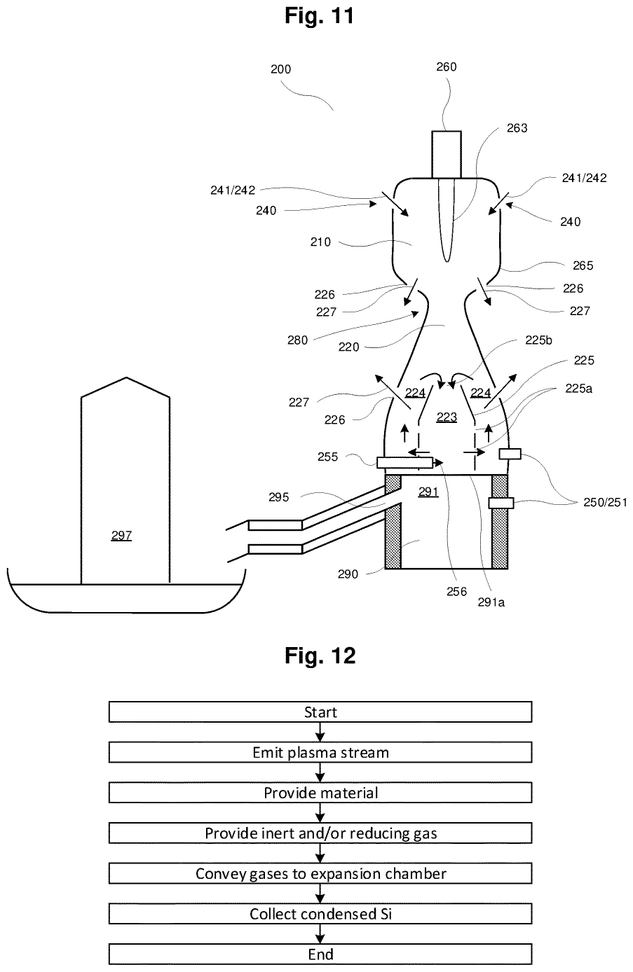

FIG. 11 is a simplified overview diagram of a second exemplary embodiment;

FIG. 12 is a flowchart showing a first method; and

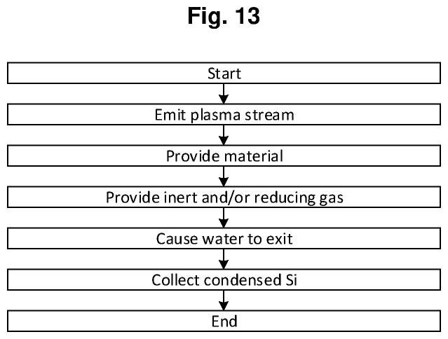

FIG. 13 is a flowchart showing a second method.

The figures share the same last digits of the reference numerals for same or corresponding parts. In addition to this and for reasons of clarity, the respective first digit of the reference numerals belonging to the two main embodiment examples presented is either “1” or “2”, depending on the embodiment.

In the following, the compound will be described as being silicon, Si, and the oxide of the compound will be described as being SiO₂. It is, however, understood that the compound can be another metal or metalloid, such as beryllium, gallium, germanium, lithium, niobium, tantalum, titanium, tungsten, vanadium, aluminium, copper, indium, lead, tellurium, zinc, nickel or cobalt; with corresponding oxides. In particular, the invention and its principles are applicable to the class of compounds comprising silicon, titanium, germanium and nickel. Among these possible compounds, silicon stands out as a specific possibility. It is also realised that sulphides of said metals or metalloids can be treated, as applicable, in a way corresponding to the treatment of the oxide described herein.

Reverting to the above discussion about a possible VEAF set-up, the present inventors have identified the use of a low-conductivity graphite crucible and a hollow graphite cathode as potentially problematic in order to achieve the present goals in some embodiments.

More concretely, it would be desirable to achieve in-flight reduction of the SiO₂, to be able to control or mitigate SiO-related side reactions (SiO-disproportionation), to be able to control H₂O-driven back reactions (reoxidation), and to be able to achieve additional stirring or agitation to a resulting Si melt with the aim of promoting homogeneity of temperature and composition.

The ability to achieve in-flight reduction in transferred arc mode is seen as less favourable due to the rapidly changing voltages associated with particles moving past the arcing electrode at various distances. Voltage is a function of distance, and the acting cathode of the arc is selected by a path of least resistance, or lowest voltage. A particle infinitesimally close to the anode would represent this lowest voltage and the power applied through the arc would either vary greatly as new particles are selected in-flight or short circuit though these particles. This results in chaotic system dynamics and increases the difficulty of system control. Therefore, controlling the arc in non-transferred mode avoids this challenge, wherein the arc occurs upstream of the input of solid particles.

In embodiments of the present invention, carrier gas and charge material is provided peripherally to the cathode, before the anode, and/or charge material is provided peripherally to the anode exit after plasmification in a way similar to thermal spray processes.

As a part of the work conducted by the present inventors, experimenting with transferred arc set-ups, approaches were considered for the production of silicon in a hydrogen reducing atmosphere similar to that of the work done on magnetite reduction in the presence of hydrogen plasma for sustainable iron ore production for the steel industry, as described in Souza Filho et al., ‘Sustainable Steel through Hydrogen Plasma Reduction of Iron Ore’.

For instance, the experimental set-up in Filho et al. was adapted to a silicon reduction experiment. However, while the hydrogen reducing atmosphere made reduction by hydrogen plasma possible through the application of a transferred arc, the benefits of hydrogen plasma alone with respect to emission and energy footprint decreases could not be obtained for silicon production.

In these experiments, SiO and Si “duveted” and blocked the SiO₂ to be reduced, and SiO readily disproportionated into Si and SiO₂, in turn hypothesised to form back into SiO again. This created a SiO—SiO₂ forming reaction loop and Si formation was very unfavourable.

The present inventors have identified in-flight reduction of SiO₂ as a method of mitigating the so-named “Duvet Effect” through (i) preventing the prolonged exposure of Si to SiO₂ for SiO production and (ii) the complete dissociation and reduction of SiO₂. As an effect of such in-flight reduction, Si can rapidly form from complete dissociation and quasi-reduction of SiO₂ in the presence of monatomic hydrogen from hydrogen plasma.

In-flight reduction allows for the dissociation of SiO₂ and H₂ into Si, H and O, which can then recombine into Si and H₂O. This, however, then creates issues of Si reacting with free O or H. To avoid this, the inventors have discovered that (i) shrouding using hydrogen and possibly also an inert gas, (ii) quenching, and/or (iii) by-product extraction may be used. This will be described in closer detail below.

Furthermore, the present inventors have realised that in-flight reduction and direct and immediate deposition into a melt of Si is effective in retaining and capturing heat energy that would otherwise require remelting of solid silicon. This, in turn, enables an integrated reduction-refinement method, wherein refinement can occur both before and during solidification while silicon is still in its molten state from reduction.

The dissociation reaction scheme shown in equations (2)-(3) below results in dissociated oxygen and hydrogen recombining after exiting the plasma stream to form steam (4). This is the background to the overall reactions of (5) and (6), but thermodynamic considerations are made to include dissociation before recombination takes place. See Miao and Grishin, ‘Gas Dynamic-Thermal-Concentration Fields and Evaporation Process of Quartz Particles in Ar—H₂ Inductively Coupled Plasma’:

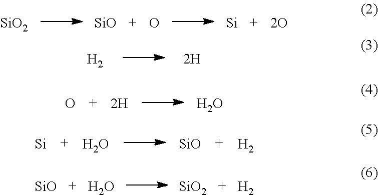

Full dissociation has the added benefit of avoiding SiO₂-duveting. However, in case the grain size of the SiO₂ is sufficiently small, full melting-dissociation can occur with a very low required retention time in high gas velocities; and SiO₂ and SiO species can be caused to be present only in the plasma stream, where these high enthalpy changes persist, and liquid silicon can be caused to be present only outside the plasma stream. The latter is further facilitated by preventing re-oxidation through shrouding, quenching and/or the rapid extraction of H₂O-byproducts.

One benefit of the present solution is to decrease the exposure of Si to H₂O or SiO₂ at high temperatures, in turn preventing re-oxidation of the silicon or production of SiO. Additional inert gas and hydrogen shrouding can be used to facilitate this at both the outer jacket of the plasma jet where the temperature decreases and only partial dissociation and reduction may have occurred. See FIG. 1a, showing hydrogen shrouding (full lines) with Ar-jackets (broken lines) to maintain gas mixtures and laminar flow in the reaction chamber. Additional hydrogen shrouding at the melt surface (FIG. 1b) prevents Si from back reacting to SiO₂. See FIG. 1b, showing the provision of a stream of H₂ to create a highly reducing atmosphere at the melt surface and to reduce local H₂O concentration. Si is reactive at the high temperatures in the dissociation-reaction zone, but re-oxidation does not occur until it drops below T=6 kK. Cooling in the T=2-6 kK zone, while still at rates of 10⁵-10⁶ K·s⁻¹, still results in re-oxidation from the reactivity of the Si with available O (recombination in the T=5-6 kK zone) and H₂O back reaction (re-oxidation) in the T=2-5 kK zone.

Rapid cooling rates can be obtained by subjecting the flow to a convergent-divergent nozzle, known as a DeLaval nozzle. Gases entering a converging section of the nozzle at a relatively higher pressure and relatively lower subsonic velocity are accelerated when pressure and thermal energy are converted into kinetic energy through mass flow continuity. This acceleration continues until the velocity of the gas reaches its Mach number at the throat of the nozzle. The flow continues to accelerate after the throat into the diverging section to reach supersonic speeds; the increase in kinetic energy is provided by the decrease in pressure and thermal energy of the flow in the diverging section.

FIG. 2 illustrates a DeLaval nozzle with a radius of curvature r equal, or at least close, to the radius R of the reaction chamber. This converges and diverges the flow rapidly over a small axial displacement. Thermal energy is hence converted into kinetic energy, and the nozzle can be dimensioned such that the target temperature of silicon flow for condensation into a liquid (T=1500° C.) can be achieved. In FIG. 2, Ar shrouding gas is illustrated using broken lines, whereas flow of active hydrogen is shown using a full-line arrow.

The Reynolds number (Re) is a dimensionless number used to describe the flow regime of a fluid. It is defined as the ratio of the inertial forces to the viscous forces in a fluid: Re=ρuL/μ. Apart from these terms density (ρ), flow velocity (u), characteristic length (L) and viscosity (μ), density is related to the pressure in that an increase in pressure will result in an increase in Re, and an increase in temperature will increase the viscosity, lowering Re.

Debris or corrosion in the nozzle could cause disturbances to the flow, increasing the likelihood of turbulent flow. Temperature variations can also cause disturbances in the flow and lead to turbulent flow. In addition, the nozzle should be designed with proper geometry, such as smooth transitions and circular cross-section, to minimize the turbulence and pressure drop.

Depositing layers have been found by the present inventors to be of a higher purity where more of this shockwave effect, amplified by the DeLaval nozzle, is used. Shockwaves result in highly turbulent zones. This shockwave, and an associated turbophoretic effect, may work to extract lighter impurities away from the Si deposition zone.

Turbophoresis is the tendency for particles to migrate in the direction of decreasing turbulence. It is not a small correction—it dominates particle dynamic behaviour in diffusion-impact and inertia-moderated regimes, such as in embodiments of the present invention active for H₂O-removal. There is a turbophoretic force on particles as the gas-liquid flow hits the silicon melt. Lower-momentum, lighter particles such as H₂O are pushed toward the wall of the deposition-extraction zone. Higher-momentum particles like the relatively higher-density liquid-Si require more of a force and are not deflected away from the melt. FIG. 3 illustrates this, using a turbophoresis axial flow velocity diagram, in an embodiment that has a gap between the crucible and the reactor walls, allowing for this overflow of lighter particles (non-Si).

The same effect in FIG. 3 persists in the embodiments shown in FIGS. 6 and 11 (see below), but H₂O is then pushed toward the walls. As these barriers impede the flow, shockwaves are created. High turbulence zones are created here; lower turbulence persists at the outer area of the expansion chamber where there is a relative decrease in flow velocity. The lighter particles, primarily lighter diatomic and triatomic particles like H₂O, experience this turbophoretic force toward the exits.

Moreover, the Saffman lift force is the force experienced in a shear flow where a force is experienced by particles toward where the flow is fastest. In embodiments of the present invention, flow will be fastest at the axial midline and at the exits, pulling by-products and impurities away. This is conceptually illustrated in FIG. 4, showing a small particle in a field of variable medium flow velocity. It is noted that the Saffman lift force is generally not as dominating as the turbophoretic effect in the present embodiments.

Thermophoresis also has a minor effect with respect to the flow of particles in the silicon melt. First lighter particles migrate to the outer layer of the plasma sheath and then toward water-cooled walls of the reactor once lower momentum particles cross turbulent boundary layers toward the reactor walls and extraction exits.

Shock-induced evaporation at the Si melt surface may also contribute to vaporising heavier metal oxide and metal-complex impurities (for instance, metal and boron oxides and hydroxides) to be effective for particles other than the silicon liquid droplets in the gas stream to be extracted away from the workpiece or melt. See Smolders and van Dongen, ‘Shock Wave Structure in a Mixture of Gas, Vapour and Droplets’. This effect has been observed in experiment by the inventors to result in high rates of silicon deposition.

FIG. 5 illustrates, in an overall flow diagram, the above-described effects, namely Saffman Lift, turbophoresis, shock-induced evaporation, and thermophoresis. It is noted that these effects work in concert to prevent impurities from reaching the silicon melt.

Since Si at high temperatures is relatively reactive (see equations (5)-(6), above) in the presence of the H₂O by-product (equation (4)), the issue of re-oxidation becomes prevalent. This problem may be mitigated using the type of protection illustrated in FIG. 2, using a shroud of Ar or another inert gas. Such an inert gas shrouding prevents H⁺ and Si⁺ ions from reacting with the nozzle material.

In some embodiments, the flushed inert gas is at a significantly lower temperature than the midline of the plasma stream. It can be injected at the edge of the stream. This achieves that the nozzle is subject to lower temperatures and rapidly quenches the temperature of the reactive flow.

In-flight reduction of SiO₂, and the deposition of the thus reduced Si directly into a silicon melt, makes the process scalable. Namely, re-heating for recrystallisation of silicon typically uses substantial amounts of energy in silicon refinement. A large velocity decrease (in experiments performed by the inventor about Mach 3.15) results in a recovery of thermal energy, contributing to maintaining the melt at a high temperature and to minimised needs for reheating. Useful ranges include above Mach 2. In some embodiments of the present invention, used ranges are less than Mach 5 or less than Mach 4.

In some embodiments, surface plasma refinement is used wherein local superheating is applied so as to volatise impurities in the form of boron and/or other metallic elements. This is useful for purifying above-metal-grade silicon to solar-grade silicon.

Temperatures required to evaporate typical metals present in quartz or other raw materials for silicon production range from 1457° C. for titanium to 3527° C. for boron. The following table shows the evaporation temperature (from a melt of liquid silicon) for a range of occurring metals:

| | Evaporation temperature |
|---|---|
| Metal | at 1 atm (° C.) |
| Al | 2327 |
| Sb | 1617 |
| B | 3527 |
| Ca | 1482 |
| Cu | 2595 |
| Mn | 2097 |
| Fe | 2727 |
| Ni | 2837 |
| Ti | 1457 |

This superheating will typically already have occurred during the in-flight reduction process of the silicon, but for impurities that are not properly vapourised and extracted, this local superheating of the melt can both vaporise such remaining impurities for extraction and input additional heat energy for maintaining the melt in a liquid state.

Such superheating can be applied intermittently or continuously, intermittent application allowing the possibility to save on energy usage. Additionally, the injection of purging gases (such as H₂O, to help volatise boron) can be used to remove boron and/or other impurities from the melt. H₂ and O₂ can also be used as purging gases. Locally applied superheating is sufficient to avoid reoxidation. In other words, superheating does not necessarily have to be applied across the whole surface of the silicon melt, but only locally, such as to one local part of the surface at a time or always to the same local part of the surface.

Superheating of the surface may be achieved by directing a high-temperature hydrogen plasma stream towards the surface, from above. Such applied hydrogen can then also contribute to a reducing atmosphere in the reactor chamber.

Alternatively, hydrogen plasma or another local superheating medium may be applied, such as using a plasmatron, below the surface of the silicon melt, then providing a mixing effect along with the aforementioned effects. As a matter of fact, in some embodiments this results in that no stirring (typically electromagnetic stirring) is required, potentially saving energy in the directional solidification process by allowing a higher cooling rate. A higher cooling rate reduces the energy required to continuously heat the melt for a controlled crystallisation front.

As an alternative to using an externally provided superheating medium designed to impinge directly onto or into the silicon melt, hydrogen gas can be employed as a shrouding gas near the surface of the silicon melt. Then, such shrouding hydrogen can be provided via a gas input lance directed at the surface of the melt (see FIG. 6, below).

it is realised that, in case other metals or metalloids than Si are purified, the temperature of the compound melt will not be caused to be higher than the melting point for the compound in question.

From the silicon melt, a communication channel can be provided, leading to a communication chamber for metallurgical refinement of the melted silicon. This communication channel can then be arranged for direct integration into a metallurgical refinement technique, such as a vacuum refinement; a float zone refinement; a directional solidification; and/or a Continuous Czochralski integration.

Turning now to FIG. 6, an exemplary device 100 is illustrated, for processing Si and/or SiO₂. In other words, the device 100 can be designed to be suitable for processing SiO₂, to produce reduced Si in a melt 191. The device 100 can also be designed to be suitable for processing Si, to also produce Si in the melt 191. In the latter case, the processing can be a pure remelting of the input Si. In other embodiments, the device 100 can be designed to be suitable for processing a mixture of Si and SiO₂.

Depending on the type of material to be processed, the presently described embodiments can be adapted in various ways so as to be adapted for such processing. For instance, the presence and design of the various mechanisms described herein for removing waste material can be varied; the use and design of a DeLaval nozzle or other type of constriction can be varied; various gas pressures, gas velocities and gas temperatures can be varied; and so forth.

The device 100 can comprise a reaction chamber 110, into which said Si and/or SiO₂ is directly introduced; and an expansion chamber 120, arranged downstream of the reaction chamber 110. It is noted that the reaction chamber 110 and the expansion chamber 120 in some embodiments can be one and the same chamber, or be two different parts of one and the same chamber, with or without a constriction 180 of different types between such sub chambers.

The device 100 further comprises a plasma generator device 160, arranged to emit a plasma stream 163 into the reaction chamber 110, the plasma stream 163 comprising said introduced Si and/or SiO₂. The plasma generator device 160 can comprise heat-resistant (refractory) material, such as tantalum and/or water-cooled steel.

In exemplifying embodiments, the device 100 is generally arranged to transport silicon material vertically downwards, from the plasma generator device 160 downwards, through the chamber(s) 110, 120 and finally down to a silicon collecting vessel 190 (see below). In such and other cases, the device 100 can be generally cylindrical, with a common vertical axis along which the silicon material is transported downwards. In such and other cases, the reaction chamber 110 can be associated with a corresponding central axis, that may be vertical or at least substantially vertical; and the expansion chamber 120 can be associated with a corresponding central axis, that may also be vertical or at least substantially vertical, and that may be the same, or at least substantially the same, as the central axis of the reaction chamber 110. In case there is only one chamber, this chamber could have a corresponding vertical or at least substantially vertical central axis, along which the silicon material flows downwards. In the following, the device 100 will be described in terms of a polar coordinate system, with an axial direction downwards; a radial direction out from the central axis; and an angular direction.

The device 100 further comprises a first material provision means 130, arranged to provide material 132 comprising the provided Si and/or SiO₂ to the plasma generator device 160. The first material provision means 130 can be a per se conventional material feeder, for instance a screw feeder or transport band feeding the silicon and/or silicon oxide in solid state, such in a granular or powder form or a fluidised powder feeding system. The first material provision means 130 can be arranged to provide the Si and/or SiO₂ as solid-state Si and/or SiO₂ having a mean particle size of between 20 and 200 μm, such as between 50 and 100 μm, preferably with more than 99% of the particles of a size within such a range. The mean particle size can be as low as 0.1 μm in the case of processing high Si wafer waste fractions, known as kerf. The grain size is generally selected so as to allow the Si and/or SiO₂ to properly flow in a quasi-continuum, and to allow full dissociation of the Si as discussed above at which grain sizes below 500 μm may be required.

In some embodiments, the SiO and/or SiO₂ is suppled at between 10 and 1000 g/min, such as between 15 and 500 g/min, for instance about 30 g/min.

The device 100 further comprises a gas provision means 170, arranged to provide at least one of an inert gas 171 and a reducing gas 172 to the reaction chamber 110. As is illustrated in FIG. 6, the gas provision means 170 can be arranged to provide at least part of the inert 171 and/or reducing gas 172 in connection to the plasma generator device 160, so that the inert 171 and/or reducing gas 172 is provided directly to the plasma stream at or in the plasma generator device 160, together with the provided Si and/or SiO₂. This means that the material 132 provided by the first material provision means 130 can comprise at least a part of the inert 171 and/or reducing 172 gas provided to the chamber, and in particular to the reaction chamber 110.

Said material can be provided coaxially in the gas stream, such as radially outside of the gas stream provided by the plasma generator device 160, or after the anode exit. In other words, the material can be supplied in a processing gas (said hydrogen and/or inert gas), and this processing gas can in turn be supplied radially externally to a main axial gas flow. The material may alternatively be provided after plasmification of the processing gas.

The device 100 can further comprise a constriction 180, such as being or comprising a DeLaval nozzle, arranged to convey gases from the reaction chamber 110 to the expansion chamber 120. In particular (but not exclusively) in case the constriction 180 is a DeLaval nozzle, it is arranged to lower the temperature and pressure of the gases passing therethrough. In some embodiments, the temperature decrease of such gases is a decrease to a temperature below the condensation temperature of Si, SiO, SiO₂, SiS and/or SiS₂. In other words, gaseous Si passing through the constriction, and in particular passing through the DeLaval nozzle, condense to liquid, or possibly solid, form.

The constriction 180 wall can comprise refractory material such as water-cooled molybdenum or high-temperature steel. It can be water-cooled. In the case of steel material, the steel material can be protected using a jacket/shroud flow of inert gas, such as argon.

Said chamber 110, 120, and in exemplifying embodiments more particularly at least the expansion chamber 120 or, can comprise an off-gas exit 126. The off-gas exit 126 can be peripherally arranged in the chamber in question, meaning that the off-gas exit 126 comprises a hole in a peripheral wall of the chamber, at a distance from said central axis of the chamber, allowing off-gases 127 to escape from the chamber in question via said hole in the peripheral hole.

The device 100 furthermore comprises a vessel 190, into which the condensed Si is deposited as a result of its flow through the device 100 and in particular through the chamber(s) 110, 120, such as along said central axis. In some embodiments, the condensed Si can be directed to deposit directly into the vessel 190 as a result of its flow after passing the constriction/DeLaval nozzle 180. The flow of the condensed Si can be directed to deposit directly from the chamber(s) 110, 120 into the vessel 190, without coming into physical contact with any parts of the device 100, as a result of the geometric arrangement of the plasma generator device 160, the chamber(s) 110, 120 and/or the constriction 180 in relation to each other.

The vessel 190 can comprise a Si melt 191 into which the condensed Si is directly deposited in said way, without first solidifying. For instance, the vessel 190 can be a trough or similar open-top container formed from a suitable material, such as a refractory material, for holding molten Si. A surface 191a of the melt 191 can be open and visible from above, so that the Si arriving from above can deposit directly into the melt 191 by simply falling down.

The Si melt 191 can be preheated so as to melt deposited solid-phase material, and in particular any solid-phase condensed Si.

It is realized that the generally vertical material-flow design illustrated in the Figures is provided for exemplary purposes, and that horizontal or slanting configurations are also possible. It is also possible for the Si to change flow direction as a result of its passing through the constriction 180, even if it is preferred that the general flow direction of the Si material is the same from the plasma generator device 160 to the vessel 190.

In general, the constriction 180 can be arranged so that condensed Si exiting the constriction 180 is directed towards, and deposited directly into, the melt 191, which can then be arranged below the constriction 180.

The plasma generator device 160 can be arranged to provide the plasma stream 163 to the vessel 190 at a velocity which is sufficient to cause H₂O in the plasma stream 163 to migrate radially outwards along the movement direction of the plasma stream 163, due to the Saffman lift force as described above, towards a region where the H₂O is caused to migrate radially outwards towards the off-gas exit 126, due to turbophoresis as also described above. Velocities to achieve this can vary depending on the general design of the device 100, but in preferred embodiments at least 50% of H₂O entrained in the material stream exiting the constriction 180 is linked off via the off-gas exit 126 this way.

Particle agglomeration occurs along streamlines at medium Stokes numbers (Stk>1, Stk<2.8). The Stokes number, Stk, is a dimensionless number defined as the ratio between the characteristic time of a particle to the characteristic time of the flow. The characteristic time of the particle can be written as, t₀=(ρₚdₚ²)/(18 μg), wherein ρₚ is the particle density, dₚ² is the particle diameter, and μ_{g} is the fluid dynamic viscosity. The effect of Stokes numbers on particle-fluid interactions are well-known as such. Clustering within this two-phase flow preferentially occurs for Stokes numbers of approximately unity, Stk≈1. Lau and Nathan, ‘The Effect of Stokes Number on Particle Velocity and Concentration Distributions in a Well-Characterised, Turbulent, Co-Flowing Two-Phase Jet’, 2016, reported particle laden compressed air resulted in clustering along the axial line at Stokes numbers above 2.8 for compressed air alumina particle laden flows, and below 2.8 clustering occurred away from the axial line; at low Stokes numbers, turbophoresis dominates, whereas at higher Stokes numbers, the Saffman lift force dominates which pushes particles of a certain characteristic to cluster in the axial line. These characteristics to promote axial clustering are described by the particle density—and for plasma spray applications as described by these embodiments, Stokes numbers above 10 and even above 20 are favourable for axial clustering of particle-laden multiphase flow, as is described by cold spray de Laval nozzle work by Meyer, Caruso, and Lupoi, ‘Particle Velocity and Dispersion of High Stokes Number Particles by PTV Measurements inside a Transparent Supersonic Cold Spray Nozzle’, 2018. Meyer et al. also describe the importance of mass loading, wherein titanium velocities at injection increase with higher injection rates and optimal Stokes numbers are found to be around 6. In embodiments of the present invention, Stokes numbers in the range of 1-10 are used to optimise turbophoretic and Saffman flow characteristics to optimise axial particle concentration and velocity.

Hence, the migration of H₂O in the plasma stream 163 radially outwards is due to varied effective Stokes numbers over the flow. As the fluid speed slows down close to the wall, turbophoresis will dominate again, but in the centre of the flow where the flow is faster and hotter Saffman dominates, so clustering will be heterogeneous over the flow. Control of the exact resulting migration of H₂O is a function of empirical parametric driven design of gas flow rates (main gas flow rate, peripheral gas flow rate, shrouding gas flow rate), as well as quenching characteristics.

The plasma generator device 160 is illustrated to comprise an anode and a cathode, both arranged upstream of the (reaction) chamber 110 and cooperating to produce the plasma stream 163.

Generally, the plasma generator device 160 can be a non-transferred arc device (such as illustrated in FIG. 6), operated using DC voltage, an AC voltage using device such as a radio frequency RF or inductively coupled plasma ICP, a microwave plasma device or a capacitively coupled plasma CCP device. In other embodiments, the plasma generator device 160 is instead a transferred arc device comprising a nozzle in turn comprising or constituting a plasma generator cathode. In the latter case, the anode can be arranged in connection to the vessel 190, such as below the vessel 190.

The cathode can be made from tungsten or tungsten oxide. The anode can be made from copper, such as using a 50 mm diameter copper anode. The plasma generator device 160 can be operated at powers ranging from about 50 kW and upwards, such as up to about 1 MW nominal power ratings.

The reducing gas provided by the gas provision means can at least in part, such as completely, be hydrogen gas. This hydrogen gas can then also at least partly be constituted by hydrogen gas being propelled by the plasma generator device 160 to create said plasma stream 163.

In some embodiments, the gas provision means 170 is arranged to provide hydrogen gas so as to achieve above-stoichiometric amounts of hydrogen for full reduction of SiO₂ present in the reaction chamber 110.

In some embodiments, the material provided to the plasma generator device 160 to form the plasma stream 163, apart from the silicon material to be processed, comprises a gas mixture of between 30% and 70% reducing gas and the remainder chemically non-reactive gas. For instance, the amount of reducing gas can be between 40% and 60% by volume, or between 45% and 55% by volume, such as about 50% by volume, whereas the reminder is then chemically non-reactive gas. In other words, the first material provision means 130 can be arranged so that the plasma stream 163 contains between 30-70% carrier gas in the form of a chemically non-reactive species and between 30-70% H₂.

In some embodiments, the total volumetric gas flow of the reducing gas and the non-reactive gas provided via the plasma generator device 160 is at least 10 slpm (standard liters per minute), such as at least 50 slpm, such as at least 100 slpm; and/or at the most 1000 slpm, such as at the most 500 slpm, such as at the most 300 slpm. In some embodiments, said total volumetric gas flow is about 160 slpm. These ratios are maintained in embodiments as a function of input power. These volumetric flow rates were sized for a nominal plasma generator power of 100 kW.

The first material provision means 130 can be arranged to provide the material 132 circumferentially around an anode of the plasma generator device 160. Alternatively, the material 132 can be provided by the first material provision means 130 through the anode. For instance, the material 132 can be provided into a cavity formed by the anode, via a hole in its side, to inside the cavity meet and be entrained into the gas material propelled in the electric field of the plasma generator device 160 and to thereby form part of the plasma stream 163 thus formed.

In such and other embodiments, the Si and/or SiO₂ provided to the plasma generator device 160 is heated in the plasma stream 163 so that the Si atoms in the plasma stream 163 have a temperature which is above the evaporation temperature of one or several of B, Ti, Al, Fe, Ca, Na, Ni, P, and/or W at the relevant operating pressure at the gas-liquid interface.

As mentioned above, the first material provision means 130 can be arranged to provide, to the plasma generator device 160 and in addition to the provided Si and/or SiO₂, and in addition to the reducing gas that in itself can be hydrogen gas, a chemically non-reactive species. The chemically non-reactive species can be any inert gas. In principle a gas such as nitrogen could be used, but the inventors have achieved good results using non-nitrogen inert gases, such as noble gases, and in particular an inert gas being or comprising at least 50% Ar.

Hence, the plasma stream 163 can comprise fractions of Si, O, Ar and H.

The reaction chamber 110 can be a vacuum chamber, in the sense that a pressure prevails therein which is decreased in relation to atmospheric pressure. In some embodiments, the pressure in the reaction chamber 110 can be at the most 800 mbar, such as at the most 100 mbar, or even at the most 50 mbar. In certain embodiments, the pressure in the reaction chamber is 1-50 mbar, such as 5-20 mbar. The expansion chamber 120 will generally have a lower mean pressure than the reaction chamber 110 because of the pressure drop over the Delaval nozzle. In case there is only one chamber, this chamber may have similar pressures as described with respect to the reaction chamber 110.

The device 100 can further comprise a second material provision means 140, arranged to supply at least one of hydrogen 141 and a chemically non-reactive species 142, such as an inert gas, the non-reactive species 142 being the same or different from the non-reactive species described above, into the reaction chamber 110. The second material provision means 140 can then be arranged to provide the hydrogen and/or the non-reactive species 142 peripherally to the plasma stream 163. In certain embodiments, the non-reactive species 142 is not provided by the plasma generator device 160 but only by the second material provision means 140, whereas in other embodiments the non-reactive species 142 is provided partly in direct connection to the plasma generator device 160 and partly by the second material provision means 140. It is noted that both the plasma generator device 160 and the second material provision means 140 debouche into the (reaction) chamber, whereby both reducing (hydrogen) gas and inert gas provided by the first material provision means 130 (in direct connection to the plasma generator device 160) and the second material provision means 140 will contribute to the chemical balance in the chamber in question.

In some embodiments, the second material provision means 140 is arranged to provide said hydrogen 141 and/or said chemically non-reactive species 142 so as to cause a laminar flow in the reaction chamber 110, and in particular in a radially outer sheath of a plasma reaction zone in the reaction chamber 110. This laminar flow can then be along the direction of the above-discussed central axis, and can be achieved by providing the hydrogen 141 and/or said chemically non-reactive species 142 via one or several input lances set at an angle so that the hydrogen 141 and/or said chemically non-reactive species 142 is provided obliquely along the flow direction of the plasma stream 163. To achieve such a laminar flow, a flow velocity of the hydrogen 141 and/or said chemically non-reactive species 142 can also be regulated, such as in relation to a flow velocity of the plasma stream 163, an internal geometry of the reaction chamber 110, an internal dimension of the reaction chamber, and so forth. This results in limited mass transport across the plasma turbulent flow and the laminar peripheral shrouding flow; mass transfer by eddy diffusion and molecular diffusion are roughly equal and eddies over large portions of the fluid do not promote significant mixing as is the case in the turbulent flow regime.

The hydrogen 141 and/or said chemically non-reactive species 142 can be supplied, for instance, via a quartz tube.

In some embodiments, the second material provision means 140 is arranged to provide the hydrogen 141 and/or chemically non-reactive species 142 so as to cause a shroud 143 around the plasma stream 163, the shroud being formed by the supplied hydrogen 141 and/or chemically non-reactive species 142. The shroud 143 can be provided anywhere along the plasma stream 163 path through the reaction chamber 110, but the inventors have found it advantageous to provide the shroud 143 so that it surrounds the plasma stream 163, in a cross-section perpendicular to the travel direction of the plasma stream 163, at a point along the travel of the plasma stream 163 located at the entry into the constriction 180. Hence, in case a DeLaval nozzle is used, the shroud 143 is then provided at the entry around silicon-containing material arriving to the DeLaval nozzle from the plasma stream 163. This way, the shrouding inert/reducing gas will form a protective jacket around the silicon-containing plasma stream 163 as is moves through a throat 182 of the nozzle.

The second material provision means 140 can be arranged to provide said hydrogen 141 and/or said chemically non-reactive species 142 at a temperature of maximally 80° C.

The device 100 can be arranged to provide a surplus of H₂ in relation to stoichiometric conditions inside the reaction chamber 110. Herein, the term “stoichiometric” refers to a stoichiometric volume flow that is just enough to reduce all provided Si and/or SiO₂ provided to the reaction chamber 110. This surplus of H₂ can then be provided entirely via the second material provision means 140, so that only at the most a stoichiometric volume flow of H₂ is provided via the first material provision means 130.

In any case, the device 100 can be arranged to provide H₂ at a surplus, in relation to stoichiometric conditions inside the reaction chamber 110, of at least 50%, such as at least 100%.

It is realized that what has been said above regarding the volume flow balance of H₂ in relation to Si and/or SiO₂ can be applied for a used single chamber rather than for a specific reaction chamber 110.

As mentioned above, silica risks partially melting and forming an insulating duvet for the remaining powder in the charge; and silica risks reacting with hydrogen at temperatures above 2000° C. to form SiO, via reaction SiO₂+H₂→SiO+H₂O, the formed SiO then depositing on substrates that would otherwise be used as anode targets in a conventional transferred arc set-up.

In contrast hereto, the evaporation, according to embodiments of the present invention, of silica particles using plasma stream 163 at temperatures of at least 3 kK, such as at least 5 kK, such as between 5 and 11 kK or even up towards 15 kK, results in atomised silica particles, in turn solving the “duvet” problem described above of using a transferred arc as a melting and reduction mechanism for silicon production. Sufficiently small atoms may be atomised readily without a shielding effect of semi-melted silica. Generally, the carrier gas in the plasma stream 163 can have a temperature of at least 3 kK, such as at least 5 kK, such as between 5 kK and 15 kK or between 5 kK and 11 kK. Further generally, the plasma generator device 160 can be arranged so that the plasma stream 163, directly after an exit 164 of the plasma generator device 160, has a temperature of at least 3 kK, such as at least 5 kK, such as between 5 and 11 kK, or even upwards of 15 kK as a maximum value.

Using a noble gas such as Ar as a carrier gas, in particular in the presence of a non-transferred arc plasma, can result in a fraction of ionised noble gas at temperatures up to at least 11 kK. Ionised Ar then heats the remaining gas in the plasma, including H₂, to at least 2 kK, such as at least 3 kK, in some embodiments even upwards towards 10 kK as a maximum temperature. By measuring or deducing this temperature in the plasma stream 163 in the reaction chamber 110, the temperature of the plasma gas exiting the reaction chamber can be calculated to achieve a target temperature as a result of rapid quenching, in turn as a result of passing the constriction 180. The quenching mechanism is relatively fixed according to equations from rocketry nozzle design; dimensioning a nozzle at the constriction 180 determines the temperature drop over the length of the nozzle throat 182. The temperature of the gas reaching the constriction 180 in the reaction chamber 110 can, for instance, be determined via empirical back calculation with the aid of CFD/MHD (Computational Fluid Dynamics/Magneto Hydro Dynamics) or Plasma Multiphysics modelling.

The temperature of the ionised gas can be modelled in non-transferred arc plasmas and AC plasmas and has been determined experimentally by the present inventors in lab tests for the following exemplifying case: the average temperature was approximately 6000 K at a distance of 0.15 m from an exit 164 of the plasma generator device 160 and at a plasma power input of 100 kW. This temperature-length configuration varies with input current and the degree of vacuum in the reaction chamber 110. The axial length 112 of the reaction chamber 110 can then be dimensioned according to the temperature drop over the axial length of the plasma stream 163 before the convergent-divergent nozzle of the constriction 180. In this particular tested example, it was found that a reaction chamber length of 1.5 m is optimal. However, the temperature value at 3.0 m depends on the used plasmatron and volumetric gas flows.

Generally, the axial length 112 of the reaction chamber 110 can be between 5 and 30 times the diameter of an exit diameter of the plasma generator device 160, such as between 8 and 20 times said exit diameter.

The present inventors have found that the use of a non-transferred arc plasma device 160 makes it possible to add the powdered Si and/or SiO₂ within the gas inlet, and allows the added Si and/or SiO₂ to fully dissociate and thereby to avoid generation of SiO. Also, the electrode consumption rate has been found to be lowered as compared to when using alternative plasma generator types. Furthermore, the reducing H₂ gas can be provided via shrouding and/or flushing as described above. Moreover, rapid quenching can be achieved via supersonic flow of the material in the plasma stream 163 through the DeLaval nozzle of the constriction 180 as will be described below.

Silica first forms SiO in an intermediate reaction en route to silicon production. The present inventors have found that the SiO₂+H₂→SiO+H₂O reaction is preferred over the SiO+H₂→Si+H₂O reaction. This has posed some problems in the development of the hydrogen-silicon production route. Namely, in the past the formation of SiO has presented a loss-mechanism wherein higher SiO presence results one of three undesirable effects: disproportionation to Si and SiO₂; removal as an off-gas; or the condensation of SiO into SiOₓ.

The production of SiO is quite rapid as a result of its favourable thermodynamics. Produced SiO can then condense and deposit onto water-cooled surfaces such as gas outlets or water-cooled crucibles for transferred arc plasma systems. To overcome this, complete dissociation can be employed. Suboptimal thermodynamic reaction routes are overridden with kinetics to ensure the availability of O₂⁻ ions to recombine with H⁺. This can be achieved by providing hydrogen at a shrouding and/or flushing rate of at least 50%, such as at least 100%, such as at least 150%, such as between 100% and 200%, of reducing (stoichiometric, see above) hydrogen flow rate in the reaction chamber 110. As described above, shrouding and/or flushing hydrogen gas can be provided via the second material provision means 140, that can be arranged in the form of auxiliary chucks within the reaction chamber 110, located at a radial distance from the plasma stream 163 and possibly being set at an angle in relation to the general flow direction of the plasma stream 163.

The reaction chamber 110, and in particular its walls, may be manufactured from zirconia, freeze lined quartz and/or steel, and may be water-cooled for the case of steel. It may also, or alternatively, be manufactured from molybdenum, with or without water-cooling. Molybdenum has been found to be able to withstand the thermal shock of initiating the plasma generator device 160. The resulting molybdenum-silicon system also retains solid molybdenum at its maximum atomic % along an isotherm of 2023° C. (see FIG. 7, indicating the pure molybdenum temperature range up to 2623° C. with a maximum stability at a 2023° C. isotherm). Other materials can be problematic due to thermal shock; this has for instance been seen for alumina. The corresponding is true regarding the expansion chamber 120.

In the following, the constriction 180 will be described. As mentioned, in some embodiments the constriction 180 comprises a convergent-divergent nozzle, such as a DeLaval nozzle.

In order to reduce the risk that Si vapour in the plasma stream 163 backreacts, with the H₂O by-product as described above, the Si vapour can be rapidly quenched using the constriction 180, and in particular by a nozzle of the constriction 180 through which the material passes between the reaction chamber 110 and the expansion chamber 120. This way, the Si vapour can be cooled to form liquid-form Si that can then be directly deposited into the melt 191. This overcomes the challenge of reducing silica at sufficient conversion rates, and it mitigates some of the high-temperature risks of the reactor in that the high-temperature, high-enthalpy plasma flow is expanded and aerodynamically quenched into a more uniform lower temperature flow at temperatures which typical refractory materials can tolerate.

To provide for suitable quenching, and to prevent recirculation back into the reaction chamber 110, one or more parameters can be considered and selected of the following: the radius 111 of the reaction chamber 110 inner wall; the radius of curvature 181a of an upstream convergent section 181 of the convergent-divergent nozzle; and the smallest radius 182a of a throat 182 of the convergent-divergent nozzle.

For instance, in some embodiments the reaction chamber 110 has a cross-sectional radius 111 of between 120% and 300% of an exit diameter of the plasma generator device 160 for under-expanded confined flow. In other embodiments, the reaction chamber radius is 3500% of the plasma generator anode exit for over-expanded flow.

In other examples, the upstream convergent section 181 of the nozzle 180 has a radius of curvature 181a which is within 50% of the cross-sectional radius 111 of the reaction chamber 110. The upstream convergent section 181 can have a constant radius of curvature 181a, or it can have a radius of curvature that stays within 50% of the cross-sectional radius 111 across at least 50% of its axial length.

The throat diameter is related to the reaction chamber through:

$$\frac{A}{{A}^{*}} = \frac{1}{Ma} {\{ \frac{2}{γ + 1} [ 1 + \frac{γ + 1}{2} {( Ma )}^{2} ] \}}^{\frac{γ + 1}{[ 2 ( γ - 1 ) ]}} ,$$

Where A=the cross-sectional area of the reaction chamber; A*=the throat area; Ma=the Mach number; and γ=isentropic expansion coefficient.

A similar relation holds for the desired expanding gas temperature as a function of the gas Mach number:

$$\frac{{T}_{0}}{T} = 1 + \frac{γ - 1}{2} {( Ma )}^{2} ,$$

Where T=temperature of the gas at the entry into the nozzle; and T₀=temperature of the gas at the exit of a downstream divergent section 183 of the nozzle.

If an isentropic expansion factor γₚ=1.48 is assumed as the weighted average of the constituent gases γ_{Ar}=1.66 and γ_{H}_{₂}=1.30, a desired temperature drop from T=6 kK can be determined to require a Mach number of Ma=3.15, as is illustrated in FIG. 8. This FIG. 8 shows a temperature drop across the convergent-divergent nozzle with respect to Mach number of the expanding gas. T₀ indicates the temperature prior to the nozzle with T being the temperature at the exit of the divergent section. The ratio between the radii r (radius of curvature of the reaction chamber 110 wall at the reaction chamber 110 converging-diverging section) and r* (radius of the throat 182 of the nozzle): A more severe decrease in radii results in a larger temperature drop.

In this example, the exit velocity is vₑ=2770 m·s⁻¹ and the expansion temperature is Tₑ=1500° C., which is above the melting point of silicon (1410° C.) and below the melting point of silica (1710° C.).

Generally, the constriction 180 can be designed to provide such an exit velocity of gasses passing through the constriction 180, and in particular of gasses exiting from the constriction 180, that is below the melting temperature of SiO₂, such as between the melting temperature of Si and that of SiO₂.

FIG. 9 shows how the exit velocity varies with entry temperature according to mass conservation in supersonic flow over a DeLaval nozzle.

Continuing the same example, a range of appropriate nozzle throat 182 radii yielding the sought-after temperature range of 1410-1710° C. gives a ratio of

$$\frac{{r}_{chamber}}{{r}_{throat}} = 1.85 - 2.15 .$$

Selecting a ratio of 2.06 achieves temperatures around Tₑ=1500° C. In this particular example this translated into a throat radius of

$${r}_{throat} = 160 \% \frac{mm}{1.67} = 0.92 \cdot {r}_{c} mm .$$

The constriction 180 itself will be subject to very high temperatures. Flushing with an inert gas, such as Ar as mentioned above, can protect the nozzle from hydrogen corrosion at these high temperatures, the inert gas surrounding the Si as a jacket and hence protecting the surface of the nozzle. In an example, Ar-flushing was conducted at a volumetric flow rate of about 200% of the initial carrier gas input, in this particular case 100 slpm. Such flushing also served to maintain the gas composition to be 50/50 Ar/H₂ by volume over the nozzle. Dimensioning for the nozzle has been performed according to this volumetric gas fraction.

As mentioned above, the reaction chamber 110 can be manufactured from molybdenum. It can also be manufactured from tantalum. In some embodiments incorporating over-expansion it can be manufactured from austenitic steel. The corresponding is true for the nozzle material. As is illustrated in FIG. 10 (showing a phase diagram for Ta—Si system), tantalum maintains its pure solid form along an isotherm of 2260° C. within the Ta—Si system.

Using in particular a non-transferred arc plasma, silica is completely dissociated, and O ions react directly with H⁺ ions. The complete dissociation of SiOx means that Si does not block further reduction. Partially reduced SiO in outer radial parts of the plasma stream 163 is directed into H⁺, due to the hydrogen shrouding and confinement in the convergent section of the nozzle. The rapid quenching achieved through the constriction 180 prevents re-oxidation of Si. As an additional advantage, evaporated boron complexes are readily above their evaporation temperatures in-flight (e.g. 3427° C.) and can therefore be separated off via radially peripheral off-gas exit 126, meaning that this temperature does not need to be achieved later, in-melt.

As mentioned above, the first phase in the plasma stream 163 flow directly after the plasma generator device 160 exit 164 has a high exit temperature, for instance T=5-11 kK. Silicon dissociation occurs in this region. Dissociated hydrogen and oxygen atoms in the plasma stream 163 recombine to form water vapour in the reaction chamber 110 in a temperature range of T=2-5 kK. Si and SiO reoxidation in this range is avoided by non-equilibrium conditions. Silicon vapour then recombines as a vapour below T<2 kK. Rapidly quenching the gas flow from this Tₜ=5 kK approximate threshold temperature effectively aids in mitigating reoxidation of Si and SiO in the 2-5 kK range.

The SiO reaction scheme 2SiO→Si+SiO₂ is something that also should be avoided below 2.2 kK through rapid gas quenching through shrouding over this temperature range (e.g. 1.8-5.0 kK). Unfavourable thermodynamics associated with these reactions can also be avoided through DeLaval nozzle rapid aerodynamic quenching below 2 kK close to the Si melting point of 1410° C.

The confinement of the reaction chamber 110 results in low mixing between the supplied gases, or at least supplied hydrogen and inert gas, due to laminar flow where all such gases can move in substantially the same direction, axially through the reaction chamber 110. This has the beneficial effect of a heterogenous radial gas composition. Where SiO is most prevalent in the lower temperature jacket of the plasma stream 163 is also where the monatomic hydrogen concentration is highest from flushing via input lance.

Generally, the plasma generator device 160, the first material provision means 130, the second material provision means 140 and the reaction chamber 110 are designed so as to achieve laminar flow of the above-described type in and through the reaction chamber 110, such as towards the constriction 180, and in applicable cases towards the DeLaval nozzle. This may entail selection of flow rates, velocities, pressures, geometry and so forth.

In contrast thereto, the constriction 180, and in particular any used DeLaval nozzle, can be arranged so as to result in a turbulent gas flow in the expansion chamber 120 and/or the reaction chamber 110. Such turbulent flow can then be prevalent at and in connection to the constriction 180 exit, and possibly also throughout the expansion chamber 120.

As is illustrated in FIG. 6, an upstream part of the expansion chamber 120 can be defined by an axially (such as downwards) expanding wall of the constriction 180, such that the downstream-arranged divergent section 183 of the constriction 180 gradually transforms into the expansion chamber 120.

In some embodiments, a diverging half-angle 183a of the downstream divergent section 183 is between 5° and 45°, such as between 6° and 34°, such as 19°. At any rate, the diverging half-angle 183a can be at least 10°, such as at least 15°; and/or the diverging half-angle 183a can be at the most 30°, such as at the most 25°.

The expansion chamber 120, downstream of the constriction 180, can generally be axially longer than the reaction chamber 110, upstream of the constriction 180. More concretely, an axial length 122 of the expansion chamber 120 may be at least 10 times, such as between 20 and 40 times, as compared to an axial length 112 of the reaction chamber 110. In overexpanded flow embodiments, the expansion chamber 120 may be at least 2 times as compared to the axial length 112 of the reaction chamber 110. Generally, the axial length of the expansion chamber 120 in relation to that of the reaction chamber 110 can be such that the ratio of the volume of the expansion chamber to the volume of the reaction chamber exceeds the ratio in the drop in pressure across the constrictor. This pressure drop is calculated by well-known nozzle flow relationships and can, for instance, be as much as a 146× reduction in pressure for a reduction in temperature of 5×. For example, if the reaction chamber operating pressure is 100 mbar, the expansion chamber pressure would then be 0.685 mbar, or 68.5 Pa.

As discussed above, the constriction 180, and in particular any used DeLaval nozzle, can be arranged so that condensed Si exiting the constriction 180 is directed towards, and deposited directly into, the melt 191 of Si provided in the vessel 190 below the constriction 180 exit.

The kinetic energy of the material stream exiting the constriction 180, which preferably is a supersonic flow, is converted back into thermal energy upon impingement into the melt 191. The converted energy is proportional to the square of the mean gas velocity less a loss term due to entropy generation. As an example, in one embodiment a target temperature is 1500° C. and is to be achieved from a constriction 180 inlet temperature of 6000 K. Then, a corresponding impingement velocity is vₑ=3027 m/s, translating into Mach 3.15 for a 50% hydrogen gas in argon, assuming a constant isentropic expansion factor as an approximation.

In general, the temperature of the stream of material exiting the constriction 180 is above the melting point of silicon, so that silicon particles therein are in liquid form.

Alternatively however, a temperature wherein silicon is a solid, below 1410° C., can be targeted in the material stream exiting the constriction 180. This would then result in an increase in temperature back into liquid form once high-temperature silicon microparticles impinge the surface of the melt.

The dimensions of the constriction 180 itself are of course fixed. However, by varying the flow of the non-reactive species 171 and/or hydrogen gas 172 provided by the first material provision means 140 into the reaction chamber 110, a quasi-virtual or fully virtual convergent-divergent nozzle can be created by the non-reactive species 171 and/or hydrogen gas 172 flowing at relatively high pressure around the silicon material through the constriction 180 throat 182, effectively compressing the silicon material radially inwards through the throat 182. A virtual convergent-divergent nozzle refers to the lack of a physical nozzle, and the constriction is provided by providing high pressure and velocity gases to constrict the flow of the particle-laden gas. Correspondingly, a quasi-virtual convergent-divergent nozzle achieves an amplified nozzle action by the use of such constricting gases. This way, the exit velocity (and hence the temperature) of the material stream from the constriction 180 can be controlled during operation.

In some embodiments, the device 100 can comprise a third material provision means 150, arranged to provide at least one of hydrogen 153 and a chemically non-reactive species 154 to the expansion chamber 120. The chemically non-reactive species 154 can be the same as the chemically non-reactive species 142. In some embodiments, it is an inert gas, such as a noble gas, for instance Ar.

The third material provision means 150 can be arranged to provide additional heat energy to the expansion chamber 120, such as directly to the melt 191. For instance, the third material provision means 150 can comprise a plasma torch 151, such as a non-transferred plasma torch 151, providing said hydrogen 153 and/or said chemically non-reactive species 154. Then, a generated plasma stream 152 of said plasma torch 151 can be arranged to impinge directly onto the melt 191 surface 191a in the vessel 190. It is noted that, using this terminology, the vessel 190 (or at least the melt 191, or at least the surface 191a) is considered to be inside the expansion chamber 120. The above-surface 191a plasma stream 152 can be delivered at a point about 30-80 mm from the surface 191a and/or at an angle of between 20° and 40°, such as 30°, to the horizontal.

Alternatively or additionally, the third material provision means 150 can comprise a plasma torch 151, such as a non-transferred plasma torch, providing said hydrogen 153 and/or said chemically non-reactive species 154 so that a plasma stream 152 thereof is arranged below the surface 191a. The below-surface 191a plasma stream 152 can be delivered at a depth of between 500 mm and 1000 mm beneath the surface 191a.

In some embodiments, the third material provision means 150 is arranged to operate the plasma torch(es) 151 in question intermittently, such as using a duty cycle of at the most 50%, such as between 20% and 50%.

In some embodiments, the third material provision means 150 is arranged to provide said hydrogen 153 and/or said chemically non-reactive species 154 by applying an electrical plasma torch power of 0-20% as compared to an electrical plasma torch power applied to produce the plasma stream 163 of the plasma generator device 160.

The third material provision means 150 can be arranged to deliver a mixture of 0-10% hydrogen; 0-10% steam; and the remainder Ar.

In addition to heating the melt 191, the third material provision means 150 removes impurities from the melted silicone, as described above.

As is illustrated in FIG. 6, the vessel 150 can also comprise a tap-off line 195 for impurities buildup, via which liquid impurities are tapped off. The tap-off line 195 is then located beneath the surface 191a. Separation occurs via the preferential segregation of impurities in a silicon melt to stay in the liquid phase. Solid phase silicon is purified but impurities build up in the liquid phase. This liquid phase is tapped-off periodically in some embodiments.

The vessel can comprise an upper part 192, arranged to accommodate the surface 191a, and a lower part 193. The lower part 193 is arranged below the upper part 192 and arranged to accommodate Si arriving from the upper part 192 in a downwards-directed flow of molten Si. The tap-off line 195 will typically be arranged in the upper part 192, where the silicon is still in liquid form.

In some embodiments, the lower part 193 comprises heating elements 194, arranged to control the height position of a solid-liquid interface 191b, of Si in the Si melt 191. The solid-liquid interface 191b will normally reside in the lower part 193. The heating elements 194 can be inductive heating elements or any other per se conventional type of heating elements.

This solid-liquid interface 191b can be controlled to a rate of via thermocouple feedback-control of the heating elements 194 within the vessel 190. Silicon product of above 99.9999% purity with less than 1 ppba boron, phosphorous/boron ratio between 0.1 and 0.5, and between 0.5 and 30 ppba metal contents are envisioned. For instance, the produced silicon product can be used as solar grade silicon or electronic grade silicon, that can be broken into ultra-high purity polysilicon chunks for sale, such as to a Czochralski refinement operator.

As mentioned above, the device can comprise an off-gas exit 126, such as one or several off-gas lances. Off-gases 127 leaving the expansion chamber 120 via these one or more offgas exits 126 can comprise OH, H₂O, metal oxides MₓO_{y}, chemically non-reactive species (such as Ar), and H₂. These impurities are linked off in the way described above, based on turbophoreses, Saffman lift and/or thermophoresis in the expansion chamber 120, and possibly also shock-induced evaporation as described above.

FIG. 11 illustrates another embodiment of a device 200 for producing Si and/or SiO₂. The device 200 is in many respects similar to device 100, and reference numerals 210, 220, 226, 227, 240, 241, 242, 260, 263, 265, 280, 290, 291, 291a and 295 have the corresponding meaning as reference numerals of FIG. 6 described above having “1” as the first digit.

As illustrated in FIG. 11, the chamber, and in particular the expansion chamber 220, comprises an inner wall 225, the inner wall 225 being coaxially arranged along the main axis of the expansion chamber 220 as defined above. Hence, the inner wall 225 can be at least partly vertical, and the inner wall 225 can be completely enclosed by the expansion chamber 220.

The inner wall 225 can comprise one or several perforations 225a through the inner wall 225 so as to allow gaseous material to exit from a radially central zone 223 in the expansion chamber 210, located inside of the inner wall 225, to a radially peripheral zone 224 in the expansion chamber 220, located peripherally outside of the inner wall 225.

The inner wall 225 can be open at an upper end 225b of the inner wall 225. The inner wall 225 can be sealed against the expansion chamber 220 floor or the vessel 290 at a lower end of the inner wall 225. The inner wall 225 can have a height of between 50% and 90% of the axial length of the expansion chamber 220, and have a diameter, perpendicular to the general flow direction inside the expansion chamber 220, that is larger than a corresponding diameter of the throat of the constriction 280.

Moreover, the peripheral zone 224 can be connected for gas communication to the one or several peripheral off-gas exits 226, arranged as discussed above in the expansion chamber 220. The peripheral zone 224 can also be open at the upper end 225b so as to thereby allow gas to flow from the peripheral zone 224 to the central zone 223.

This way, the inner wall 225 will form a pressure-differentiating barrier, maintaining a higher pressure in the central zone 223 as compared to a pressure in the peripheral zone 224. High-velocity material arriving from the constriction 280 will pass primarily directly into the central zone 223, towards the melt 291, and Si will deposit into the melt 291. Impurities will pass via perforations 225a, via the above-described mechanisms, and exit via off-gas exits 226. Recirculation takes place back into the central zone 223 over said upper end 225b. This will achieve a more efficient separation process of impurities other than Si to be deposited, also for impurities exiting from the melt 291 as a consequence of the impinging Si stream into the melt 291.

The device 200 can also comprise a fourth material provision means 255, arranged to provide hydrogen gas 256 to the central zone 223 for additional reducing potential, in some embodiments at rates of 10-50% volumetric flow rates of the main gas provision: i.e. 50 slpm of hydrogen for the plasma gas would require 5-25 slpm of supporting hydrogen gas to decrease product concentrations and decrease the propensity of the system—the silicon—to backreact with H₂O. In some embodiments, this hydrogen 256, that may be additional hydrogen provided in addition to hydrogen already provided via the first, second 240 and/or third 250 material provision means in the general manner described above, is provided as a gas stream directly into the central zone 223, such as via a per se conventional lance, and not a plasmatron.

The vessel 290 can be in liquid communication with a different chamber for various postprocessing of the resulting liquid-state silicon.

FIG. 12 illustrates a first method, for processing Si and/or SiO₂, using a device 100, 200 of the general type described above.

In a first step, the method starts.

In a subsequent step, the plasma generator device 160, 260 is caused to emit the plasma stream 163, 263 into the reaction chamber 110, 210, the plasma stream 163, 263 comprising Si and/or SiO₂. In some embodiments, the plasma stream 163, 263 comprises no, or at most 20%, Si by mass. In some embodiments, the plasma stream 163, 263 comprises no, or at most 20%, SiO₂ by mass. In the former case, the process is for reducing SiO₂ into Si; in the latter case, the process is for remelting of solid-state Si. In other cases, the plasma stream 163, 263 comprises both Si and SiO₂, whereby the process is for both reduction and remelting.

In another step, the first material provision means 130 is caused to provide the material 132 comprising the Si and/or SiO₂ to the plasma generator device 160, 260.

In another step, the gas provision means 170 is caused to provide the inert 171 and/or reducing 172 gas to the reaction chamber 110, 210 as described above.

In another step, the constriction 180, 280 is caused to convey gases from the reaction chamber 110, 210 to the expansion chamber 110, 210, thereby lowering the temperature of the gases passing through the constriction 180, 280 to below the condensation temperature of Si, SiO, SiO₂, SiS and/or SiS₂, so that gaseous Si passing through the constriction 180, 280 condenses, into a liquid or solid phase.

In another step, the condensed Si (and/or its oxide and/or its sulphide) is directed into, and collected in, the vessel 190, 290 without first solidifying.

In a subsequent step, the method ends.

It is noted that these steps are typically performed concurrently, in a continuous process. The resulting molten silicon can be caused to migrate downwards to the lower part 193 of the vessel 190 to solidify therein, and/or be conveyed to the chamber 297 for further processing, as the case may be.

FIG. 13 illustrates a method for processing Si and/or SiO₂. The FIG. 13 embodiment is similar to the FIG. 12 embodiment, why the following description focusses on the differences.

In a first step, the method starts.

In a subsequent, step, the plasma generator device 160, 260 is caused to emit the plasma stream 163, 263 into the chamber 110, 120, 210, 120, such as to the reaction chamber 110, 210.

In another step, the first material provision means 130 is caused to provide material 132 comprising the Si and/or SiO₂ to the plasma generator device 160, 260.

In another step, the gas provision means 170 is caused to provide the inert 171 and/or reducing 172 gas to the chamber 110, 120, 210, 120.

In a subsequent step, H₂O is caused to exit the chamber 110, 120, 210, 120 via the peripherally arranged off-gas exit(s) 126, 226. This can take place as described above, exploiting turbophoresis, Saffman lift forces, thermophoresis and/or shock-induced evaporation.

In another step, the condensed Si is directed into, and collecting in, the vessel 190, 290 without first solidifying.

In a subsequent step, the method ends.

It is noted that the methods described herein are generally automatically or semi-automatically performed, using a control device connected to various sensors (pressure sensors, temperature sensors, flow sensors, and so forth) and actuators (flow control, temperature control, pressure control, etc.) so as to control the process. Such control device, sensors and actuators can be conventional as such, and are not described in detail herein.

Above, preferred embodiments have been described. However, it is apparent to the skilled person that many modifications can be made to the disclosed embodiments without departing from the basic idea of the invention.

For instance, the device 100, 200 can have many additional components not described herein. For instance, various pre- and post-processing steps can be employed with respect to the silicon material processed. Furthermore, the various gas- and material provision means 130, 140, 150, 170 can be per se conventional provision means; gas may be provided from a pressurized gas source, via gas conduits and controllable valves; whereas solid-state material can be provided using screw feeders, belt feeders, pressurized air feeders and in any other per se conventional manner.

In general, all that has been said regarding any of the devices described herein and the methods described herein is freely combinable unless not compatible.

Hence, the invention is not limited to the described embodiments, but can be varied within the scope of the enclosed claims.

As mentioned above, the principles presented herein can be employed also to produce other compounds than silicon with high purities.

Applying the present invention to materials beyond silicon then involves vapourising an oxide and/or sulphide beyond the point at which it will dissociate (e.g. above 5 kK). Following this, gas quenching can be used to both (a) protect the refractory materials used in the reactor for the reaction chamber and the convergent-divergent nozzle and (b) provide conditions to nucleate only the desired compound while removing H₂O and other byproducts. The compound is then isolated from reacting along back- and side-reaction pathways through the aerodynamic quenching over the convergent divergent nozzle. A table of materials and their target quenching temperature demonstrates this below. Note that certain materials can be quenched to temperatures below their melting point, producing a solid powder within a gas flow in the target vessel. The axial/auxiliary gas flow rates with respect to input plasma power can be selected according to the Gibbs free energy of the oxide reduction reaction and the reactivity of the associated compound; the ratio of areas of the nozzle throat A* to the area of the reaction chamber A are selected according to the desired target temperature range.

| | | Melting point of | Target | Axial/aux | |
|---|---|---|---|---|---|
| Metal | Oxide | oxide/metal (° C.) | temperature (° C.) | (slpm/kW) | (A*/A) |
| Beryllium | BeO | 2530/1287 | 1300-1500 | 1.2/0.5 | 3-6 |
| Gallium | Ga₂O₃ | 1740/29.8 | 40-100 | 0.6/1.8 | 20-40 |
| Germanium | GeO₂ | 1115/938 | 1000-1300 | 1.5/0.7 | 4-8 |
| Lithium | Li₂O | 1700/180 | 200-400 | 0.3/1.0 | 15-30 |
| Niobium | Nb₂O₅ | 1512/2477 | 600-1000 | 1.8/1.2 | 5-15 |
| Tantalum | Ta₂O₅ | 1872/3017 | 600-1000 | 1.8/1.2 | 5-15 |
| Titanium | TiO₂ | 1843/1668 | 600-1000 | 2.2/1.0 | 10-20 |
| Tungsten | WO₃ | 1473/3422 | 600-1000 | 1.8/1.0 | 5-15 |
| Vanadium | V2O₅ | 690/1910 | 600-1000 | 1.6/1.1 | 5-15 |
| Aluminium | Al₂O₃ | 2072/660 | 800-1000 | 0.7/0.5 | 6-14 |
| Copper | Cu₂O, | 1201 (Cu2O), | 1100-1400 | 0.5/1.2 | 3-7 |
| | CuO | 1326 (CuO)/1085 | | | |
| Indium | In₂O₃ | 1910/156 | 700-900 | 1.0/1.2 | 5-15 |
| Lead | PbO | 888/328 | 1000-1200 | 1.0/0.8 | 3-9 |
| Tellurium | TeO₂ | 732/450 | 600-800 | 1.2/0.8 | 5-15 |
| Zinc | ZnO | 1975/420 | 800-1100 | 1.5/0.8 | 5-15 |
| Nickel | NiO | 1455/1984 | 1000-1400 | 1.2/0.5 | 3-7 |
| Cobalt | Co₃O₄ | 1495/895 | 900-1300 | 0.8/0.5 | 5-9 |

For sulphides, in which roasting and reduction can occur simultaneously with hydrogen, the following inputs may be used:

| | | Processing | | | | | |
|---|---|---|---|---|---|---|---|
| | | step | | | Target | | |
| | | (sulphide −> | Process | Hydrogen | quench | Ar + H₂ | |
| | | oxide or | temp. | reduction | temp. | axial flow | Constriction |
| Metal | Sulphide | metal) | (° C.) | step | (° C.) | (slpm/kW) | ratio A*/A |
| Molybdenum | MoS₂ | Roasting | 500-700 | MoO₃ + | 600-840 | 0.62-0.96 | 1.74-2.43 |
| | | (MoS₂ → | | 3H₂ −> Mo + | | | |
| | | MoO₃, SO₂) | | 3H2O | | | |
| Nickel | NiS, | Roasting | 600-800 | NiO + H₂ −> | 720-960 | 0.72-1.14 | 2.09-2.78 |
| | Ni₃S₂ | (NiS, Ni₃S₂ → | | Ni + H₂O | | | |
| | | NiO, SO₂) | | | | | |
| Copper | CuS, | Roasting | 500-800 | Cu₂O + H₂ −> | 600-960 | 0.62-1.14 | 1.74-2.78 |
| | Cu₂S | (CuS, Cu₂S −> | | 2Cu + | | | |
| | | Cu₂O, SO₂) | | H₂O | | | |
| Indium | (from | Roasting ZnS | 500-800 | In₂O₃ + | 600-960 | 0.62-1.14 | 1.74-2.78 |
| | ZnS | (ZnS −> ZnO, | | 3H₂ −> 2In + | | | |
| | ores) | SO₂), then | | 3H₂O | | | |
| | | separate In | | | | | |
| Lead | PbS | Roasting | 800-1000 | PbO + H₂ −> | 960-1200 | 1.14-1.52 | 2.78-3.48 |
| | | (PbS −> PbO, | | Pb + H₂O | | | |
| | | SO₂) | | | | | |
| Tellurium | (from | Roasting CuS | 500-800 | TeO₂ + H₂ −> | 600-960 | 0.62-1.14 | 1.74-2.78 |
| | Cu | (CuS −> Cu₂O, | | Te + H₂O | | | |
| | ores) | SO₂), then | | | | | |
| | | separate Te | | | | | |
| Zinc | ZnS | Roasting (ZnS −> | 800-1000 | ZnO + H₂ −> | 960-1200 | 1.14-1.52 | 2.78-3.48 |
| | | ZnO, SO₂) | | Zn + H₂O | | | |

1. A device for processing a substance, its oxide and/or its sulphide, the substance being a metal or metalloid, the device comprising
a reaction chamber and an expansion chamber;
a plasma generator device, arranged to emit a plasma stream into the reaction chamber, the plasma stream comprising the substance, its oxide and/or its sulphide;
a first material provision means, arranged to provide material comprising the substance, its oxide and/or its sulphide to the plasma generator device;
a gas provision means, arranged to provide an inert and/or reducing gas to the reaction chamber;
a DeLaval nozzle, arranged to convey gases from the reaction chamber to the expansion chamber, the DeLaval nozzle being arranged to lower the temperature of the gases passing through the DeLaval nozzle to below the condensation temperature of the substance, its oxide and/or its sulphide, so that said substance, oxide and/or sulphide entering the DeLaval nozzle in gaseous form as a result from passing through the DeLaval nozzle condenses into a liquid or solid phase;
a vessel, into which the condensed substance is directed by the DeLaval nozzle; and
a third material provision means, arranged to provide at least one of hydrogen and a chemically non-reactive species, such as an inert gas, to the expansion chamber.

2. The device according to claim 1, wherein
the plasma generator device is a non-transferred arc device operated using DC voltage, an AC voltage using device such as a radio frequency RF or inductively coupled plasma ICP, a microwave plasma device or a capacitively coupled plasma CCP device.

3. The device according to claim 1, wherein
the gas provision means is arranged to provide hydrogen so as to achieve above-stoichiometric amounts of hydrogen for full reduction of an oxide of the substance present in the reaction chamber.

4. The device according to claim 1, wherein
the first material provision means is arranged to provide the material circumferentially around an anode of the plasma generator device or through the anode.

5. The device according to claim 1, wherein
the first material provision means is arranged to provide the substance, its oxide and/or its sulphide as solid-state substance, oxide and/or sulphide having a mean particle size of between 20 and 200 μm, such as between 50 and 100 μm, preferably with more than 99% of the particles of a size within such a range.

6. (canceled)

7. The device according to claim 1, wherein
the first material provision means is arranged to provide at least one of hydrogen and a chemically non-reactive species, such as an inert gas, to the plasma generator device, in addition to the substance, its oxide and/or its sulphide, the chemically non-reactive species possibly being Ar, He, or N2.

8. The device according to claim 1, further comprising
a second material provision means, arranged to supply at least one of hydrogen and a chemically non-reactive species, such as an inert gas, into the reaction chamber peripherally to the plasma stream, the chemically non-reactive species possibly being Ar, He, or N2.

9. The device according to claim 8,
the second material provision means being arranged to provide said hydrogen and/or said chemically non-reactive species so as to cause a laminar flow in a radially outer sheath of a plasma reaction zone in the reaction chamber.

10. The device according to claim 9,
the second material provision means being arranged to provide said hydrogen and/or said chemically non-reactive species so as to cause a shroud of the supplied hydrogen and/or the chemically nonreactive species upon entry into the DeLaval nozzle, the shroud being provided at the entry around material arriving to the DeLaval nozzle from the plasma stream.

11. The device according to claim 8, wherein
the second material provision means is arranged to provide said hydrogen and/or said chemically non-reactive species at a temperature of maximally 1500° C.

12-13. (canceled)

14. The device according to claim 1, wherein
the reaction chamber is a vacuum chamber having a pressure of at the most 800 mbar, such as at the most 100 mbar, such as between 1 and 50 mbar, such as between 5 and 20 mbar.

15. The device according to claim 1, wherein
the first material provision means is arranged so that the plasma stream contains between 30-70% carrier gas in the form of a chemically non-reactive species and between 30-70% H2.

16. The device according to claim 15, wherein
the carrier gas in the plasma stream has a temperature of 5-15 kK resulting from energy applied to the gas via DC or AC circuit.

17-18. (canceled)

19. The device according to claim 1, wherein
the reaction chamber has a cross-sectional radius of between 120% and 300% of an exit diameter of the plasma generator device.

20. The device according to claim 1, wherein
an upstream convergent section of the DeLaval nozzle has a radius of curvature which is within 50% of a cross-sectional radius of the reaction chamber.

21. (canceled)

22. The device according to claim 1, wherein
the DeLaval nozzle is designed to provide an exit velocity of gasses passing through the DeLaval nozzle that is below the melting temperature of the oxide.

23. The device according to claim 22, wherein
the DeLaval nozzle is designed to provide an exit velocity of gasses passing through the DeLaval nozzle that is between the melting temperature of the substance and that of its oxide.

24-30. (canceled)

31. The device according to claim 1, wherein
the vessel comprises an upper part, arranged to accommodate an upper surface of liquid substance deposited from the plasma stream, and a lower part, arranged below the upper part and to accommodate the substance arriving from said upper part, and wherein
the lower part comprises heating elements arranged to control a solid-liquid interface of the substance in the substance melt.

32. The device according to claim 1, wherein
the vessel comprises a tap-off line for liquid impurities, arranged below a liquid surface of liquid substance deposited from the plasma stream and present in the vessel.

33. A method for operating a device according to claim 1 for processing the substance, its oxide and/or its sulphide, the substance being a metal or metalloid, the method comprising
causing the plasma generator device of the device to emit a plasma stream into the reaction chamber of the device, the plasma stream comprising the substance, its oxide and/or its sulphide;
causing the first material provision means of the device to provide material comprising the substance, its oxide and/or its sulphide to the plasma generator device;
causing the gas provision means of the device to provide an inert and/or reducing gas to the reaction chamber;
causing the DeLaval nozzle of the device to convey gases from the reaction chamber to the expansion chamber, thereby lowering the temperature of the gases passing through the DeLaval nozzle to below the condensation temperature of the substance, its oxide and/or its sulphide, so that the substance, oxide and/or sulphide entering the DeLaval nozzle in gaseous form as a result from passing through the DeLaval nozzle condenses into a liquid phase; and
directing the condensed substance into, and collecting the condensed substance in, the vessel of the device.

34-35. (canceled)
